(19) United States
(12) Patent Application Publication
(10) Pub. No.: US 2025/0138254 A1
(43) Pub. Date: May 1, 2025

(54) EXTERNAL INSTALLED RAMPS FOR OPTICAL ADAPTERS

(71) Applicant: Sumitomo Electric Lightwave Corp., Raleigh, NC (US)

(72) Inventors: Guilherme Doro Roncoleta, Irvine, CA (US); Daizo Nishioka, Irvine, CA (US)

(21) Appl. No.: 18/818,871

(22) Filed: Aug. 29, 2024

Related U.S. Application Data
(60) Provisional application No. 63/546,687, filed on Oct. 31, 2023.

(51) Int. Cl. G02B 6/38

(52) U.S. Cl. CPC G02B 6/3898

(57) ABSTRACT

A ramp adapter for guiding connectors of cables into a port of a connector adapter for coupling cables together. The ramp adapter has an extension portion that abuts a side of and extends away from the connector adapter when the ramp adapter is attached to the connector adapter. Fastening portions are attached to the extension portion and removably attach the ramp adapter to the connector adapter. One or more grips can be grasped by a user to guide the ramp adapter onto or away from the connector adapter during installation of the ramp adapter onto the connector adapter and during removal of the ramp adapter from the connector adapter. The extension portion supports and guides a connector attached to one of the cables into the designated port of the connector adapter during insertion of the connector into the designated port.

### CROSS-REFERENCE TO RELATED APPLICATION

This application claims priority to U.S. Provisional Patent Application Ser. No. 63/546,687, filed on Oct. 31, 2023, the disclosure of which is incorporated by reference herein in its entirety.

### BACKGROUND

The rapid growth of e-commerce, video streaming services, and cloud computing services requires a commensurate rapid growth in computing infrastructure, including locations commonly referred to as “datacenters.” In order for a datacenter to be operational, however, not only must each of the computer servers be installed within racks in the datacenter and provided with power, but these computer servers must be interconnected together and/or with communications equipment (e.g., switches) that is also provided within such datacenters, such that data can be transferred to/from/between each of these computer servers for performing a designated function.

Due to the proliferation of high-speed internet connections for users, the need for increased data transmission bandwidth continues to increase. One of the most efficient data transfer cable mediums is fiber optic cable, through which a signal can travel at speeds approaching the speed of light. However, such fiber optic cables must first be “terminated,” meaning to have a connector rigidly attached to the end of the fiber optic cable. These connectors allow for a rigid connection between the fiber optic cable and the computer infrastructure device (e.g., computer or switch) that ensures uninterrupted receipt/transmission of data through the fiber optic cable, while also protecting the fiber optic cable from being damaged.

When building a datacenter, data transmission cables, such as fiber optic cables, must be connected between computer servers and/or switches. However, the act of “terminating” a fiber optic cable is very time and labor intensive. Thus, the use of pre-terminated cables can be used to significantly reduce the amount of time required to bring new datacenters online, since the cable termination step can be omitted. It is often necessary for fiber optic cables to be connected to an adapter mounted within a panel. However, the handling of such pre-terminated cables by datacenter installation personnel and the connection of such pre-terminated cables to an adapter is cumbersome at present. Thus, a need exists for a device suitable for use with such adapters that simplifies the installation of such pre-terminated cables in the adapters.

### SUMMARY

According to an example embodiment disclosed herein, a ramp adapter is provided for guiding connectors of cables into a designated port of one or more connector adapters that is configured for coupling cables together. According to this example embodiment, the ramp adapter comprises features including: an extension portion that is configured to abut against a side of the one or more connector adapters that has/have the designated port when the ramp adapter is removably attached to the one or more connector adapters, wherein the extension portion extends away from the one or more connector adapters when the ramp adapter is removably attached to the one or more connector adapters; fastening portions that are attached to the extension portion and are configured to removably attach the ramp adapter to the one or more connector adapters; and one or more grips that are configured to be grasped by a user to guide the ramp adapter onto or away from the one or more connector adapters during installation of the ramp adapter onto the one or more connector adapters and during removal of the ramp adapter from the one or more connector adapters. According to this example embodiment, the extension portion is configured to support and guide a connector attached to one of the cables into the designated port of the one or more connector adapters during insertion of the connector into the designated port.

According to any of the example embodiments of the ramp adapter disclosed herein, the extension portion can comprise a plurality of channels that are defined by dividers.

According to any of the example embodiments of the ramp adapter disclosed herein, a quantity of the plurality of channels is the same as a quantity of ports of the one or more connector adapters to which the ramp adapter is configured to be removably attached.

According to any of the example embodiments of the ramp adapter disclosed herein, the extension portion has a sloped surface on which the connector of the cable being inserted is supported, the sloped surface being angled such that, at an upper edge of the extension portion, the sloped surface and the ports of the one or more connector adapters are continuous with each other.

According to any of the example embodiments of the ramp adapter disclosed herein, the sloped surface and a bottom surface of the ports of the one or more connector adapters are arranged at an obtuse angle relative to each other.

According to any of the example embodiments of the ramp adapter disclosed herein, at the side of the one or more connector adapters in which the designated port is located, the sloped surface and the bottom surface of the designated port are at a same height as each other.

According to any of the example embodiments of the ramp adapter disclosed herein, the upper edge of the extension portion is coplanar with the bottom surface of the ports of the one or more connector adapters and all other parts of the sloped surface of the extension portion are below plane defined by the bottom surface of the ports.

According to any of the example embodiments of the ramp adapter disclosed herein, the upper edge of the extension portion is coplanar with the bottom surface of the ports of the one or more connector adapters and all other parts of the sloped surface of the extension portion are below plane defined by the bottom surface of the ports.

According to any of the example embodiments of the ramp adapter disclosed herein, the dividers are located so that located so that each channel of the plurality of channels is substantially coaxially aligned with a corresponding one of the ports of the one or more connector adapters.

According to any of the example embodiments of the ramp adapter disclosed herein, the extension portion comprises a ramp.

According to any of the example embodiments of the ramp adapter disclosed herein, the ramp adapter has a unitary or monolithic construction.

According to any of the example embodiments of the ramp adapter disclosed herein, during insertion of the connector into the designated port, the connector slides along the extension portion and a ferrule of the connector does not directly contact the ramp adapter.

According to any of the example embodiments of the ramp adapter disclosed herein, the ramp adapter is made from one or more of a plastic material, a ceramic material, and a metal material.

According to any of the example embodiments of the ramp adapter disclosed herein, the ramp adapter consists of a plastic material, a ceramic material, or a metal material.

According to any of the example embodiments of the ramp adapter disclosed herein, the ramp adapter consists of one or more of a plastic material, a ceramic material, and a metal material.

According to any of the example embodiments of the ramp adapter disclosed herein, the ramp adapter is configured to be removably attached to a plurality of connector adapters.

According to any of the example embodiments of the ramp adapter disclosed herein, the plurality of connector adapters are installed in a connector housing installation housing.

According to any of the example embodiments of the ramp adapter disclosed herein, the cables are fiber optic cables.

### BRIEF DESCRIPTION OF THE DRAWINGS

One or more example embodiments of the disclosed device are described herein, with reference to the accompanying drawings, in which:

FIGS. 1A and 1B are respective schematic illustrations showing the internal construction of an example fiber optic cable.

FIG. 2 is a perspective view of an example embodiment of a fiber optic 2-port connector adapter.

FIG. 3 is a side view of the connector adapter shown in FIG. 2.

FIG. 4 is a front view of the connector adapter shown in FIGS. 2 and 3.

FIG. 5 is a perspective view of an example embodiment of a connector adapter installation housing for having a plurality of connector adapters shown in FIGS. 2-4 installed therein.

FIG. 6 is a front view of the connector adapter installation housing shown in FIG. 5.

FIG. 7 is a perspective view of a first example embodiment of a ramp adapter for installation on the example connector adapter shown in FIGS. 2-4.

FIG. 8 is a side view of the first example embodiment of the ramp adapter shown in FIG. 7.

FIG. 9 is a front view of the first example embodiment of the ramp adapter shown in FIGS. 7 and 8.

FIG. 10 is a rear view of the first example embodiment of the ramp adapter shown in FIGS. 7-9.

FIG. 11 is a perspective view of the first example embodiment of the ramp adapter shown in FIGS. 7-10 installed on the connector adapter shown in FIGS. 2-4.

FIG. 12 is a front view of the first example embodiment of the ramp adapter shown in FIGS. 7-10 installed on the connector adapter shown in FIGS. 2-4.

FIG. 13 is a perspective view of a second example embodiment of a ramp adapter for installation on a plurality of the example connector adapters shown in FIGS. 2-4, when the connector adapters are installed in the example connector adapter installation housing shown in FIGS. 5 and 6.

FIG. 14 is a side view of the second example embodiment of the ramp adapter shown in FIG. 13.

FIG. 15 is a front view of the second example embodiment of the ramp adapter shown in FIGS. 13 and 14.

FIG. 16 is a rear view of the second example embodiment of the ramp adapter shown in FIGS. 13-15.

FIG. 17 is a perspective view of the second example embodiment of the ramp adapter shown in FIGS. 13-16 installed on a plurality of the example connector adapter shown in FIGS. 2-4, which are installed in the example connector adapter installation housing shown in FIGS. 5 and 6.

FIG. 18 is a front view of the second example embodiment of the ramp adapter shown in FIGS. 13-16 installed on a plurality of the example connector adapter shown in FIGS. 2-4, which are installed in the example connector adapter installation housing shown in FIGS. 5 and 6.

FIG. 19 is a perspective, partially exploded view of a third example embodiment of the ramp adapters that are aligned with a plurality of the example connector adapter shown in FIGS. 2-4, which are installed in another example embodiment of a connector adapter installation housing, for attaching the ramp adapters to such connector adapters and the connector adapters installation housing.

FIG. 20 is a side, partially exploded view of the third example embodiment of the ramp adapters that are aligned with a plurality of the example connector adapter shown in FIGS. 2-4, which are installed in another example embodiment of a connector adapter installation housing, for attaching the ramp adapters to such connector adapters and the connector adapters installation housing.

The drawings are not necessarily to scale. The drawings are merely representations, not intended to portray specific parameters of the disclosure. The drawings are intended to depict example embodiments of the disclosure, and therefore are not to be considered as limiting in scope. In the drawings, like numbering represents like elements.

### DETAILED DESCRIPTION

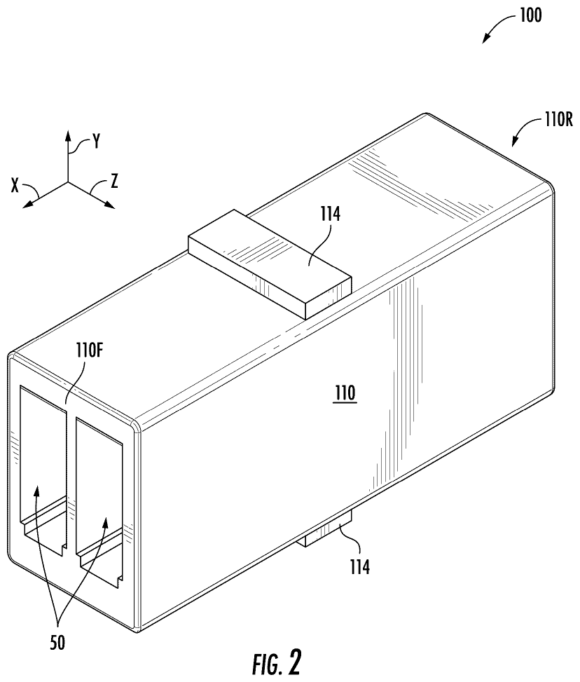

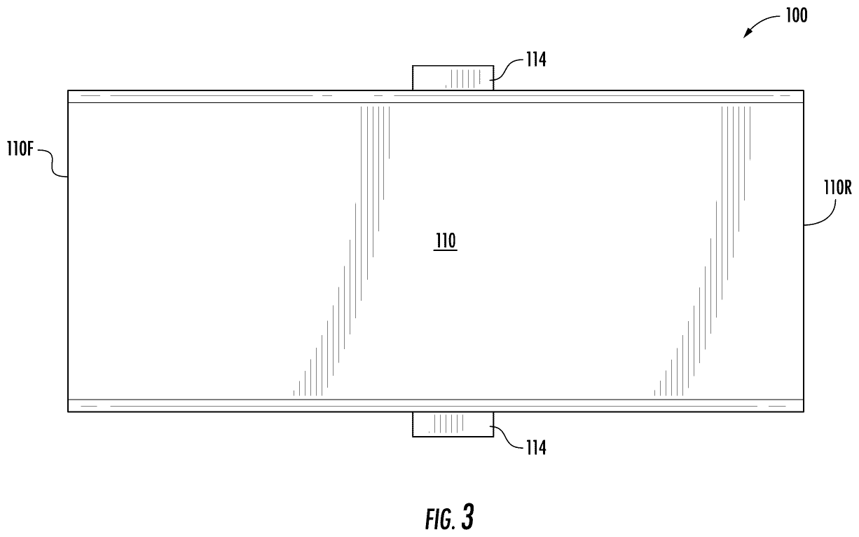

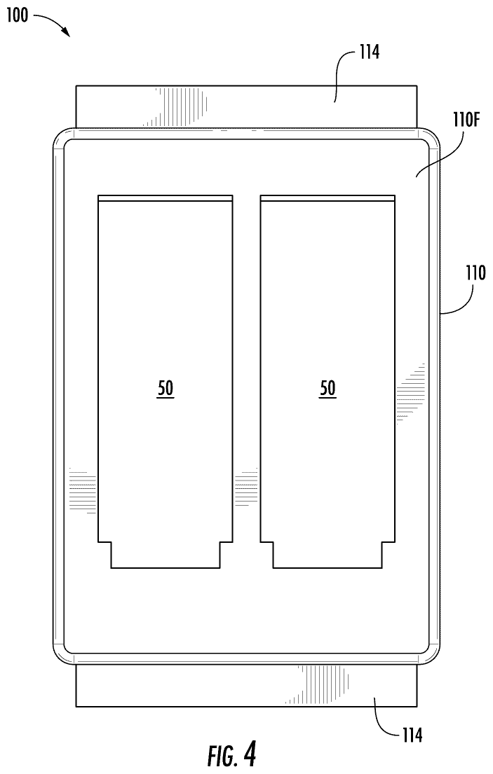

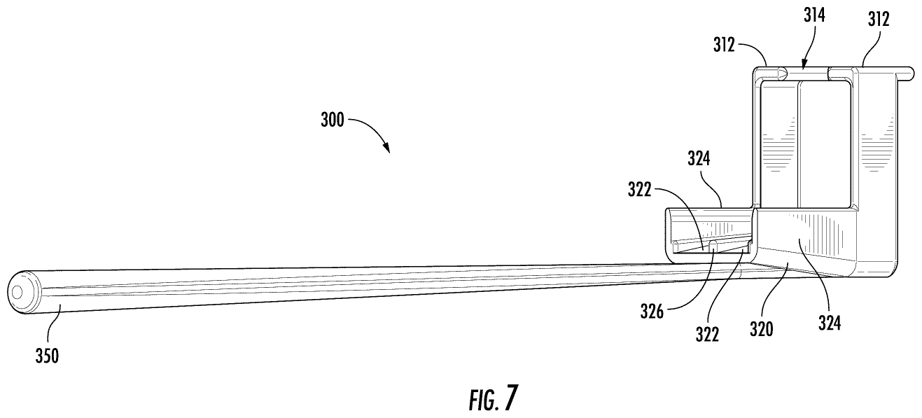

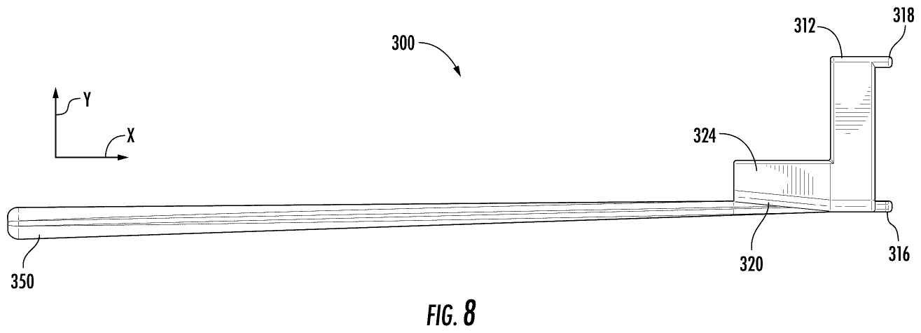

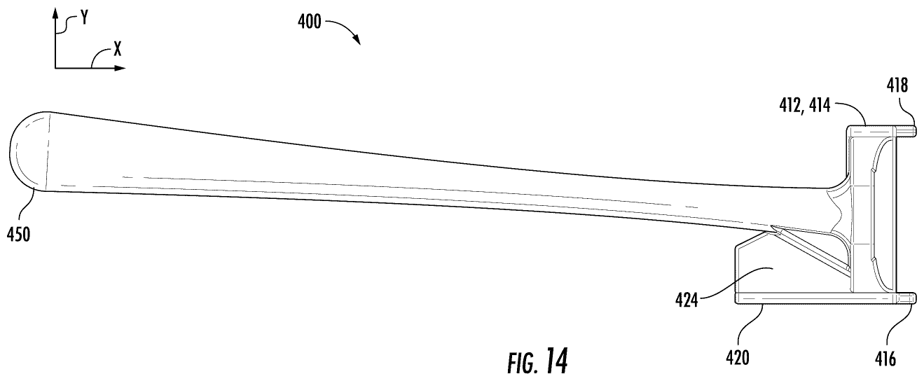

Example embodiments of a ramp adapter (e.g., 300, 400, 401, see FIGS. 7-20) for removable installation onto a fiber optic connector adapter (see, e.g., 100, FIGS. 2-4, 17-20), in accordance with the present disclosure, will now be described more fully hereinafter with reference to the accompanying drawings, in which preferred embodiments of the present disclosure are presented. The ramp adapter(s) of the present disclosure may, however, be embodied in many different forms and should not be construed as being limited to the embodiments set forth herein. Rather, these embodiments are provided so that this disclosure will convey certain example aspects of such ramp adapter(s) to those skilled in the art. In the drawings, like numbers refer to like elements throughout unless otherwise noted.

The example embodiments of the ramp adapters disclosed herein are configured for use with (e.g., to have inserted therein) fiber optic cable connectors. These fiber optic cables can be either pre-terminated or terminated with connectors in situ before such connectors are plugged into one of the ports of the connector adapter. In some embodiments, the ramp adapters may be designed so as to be operable with connector adapters that are designed for use with cable types other than fiber optic cables. In some embodiments, the ramp adapters disclosed herein are designed to be installed on a plurality of connector adapters that are installed within a connector adapter installation housing.

An example embodiment for a connector adapter, generally designated 100, is shown in FIGS. 2-4. Such a connector adapter 100 is designed as a way to provide a secure and robust connection between a respective connector of two cables. Thus, each port 50 on one side of the connector adapter 100 is arranged substantially coaxial to a corresponding one of the ports 50 on the other, opposite side of the connector adapter 100. The core 1 of each fiber optic cable installed into one of the coaxially-aligned pairs of ports 50 of the connector adapter 100 is thus also substantially coaxially aligned with the core 1 of another fiber optic cable that has a connector installed within the other, longitudinally opposite, port 50 of the connector adapter 100. Thus, by plugging a connector of a first fiber optic cable into a first port 50 that is, for example, on the front side 110F of the housing 110 of the connector adapter 100, and by plugging a connector of a second fiber optic cable into a second port 50 that is, for example, on the rear side 110F of the housing 110 of the connector adapter 100, the core 1 secured in the first port 50 by the connector of the first fiber optic cable is coaxially aligned with the core 1 secured in the second port 50 by the connector of the second fiber optic cable, such that a signal may be transmitted from, to, and/or between the first fiber optic cable and the second fiber optic cable and, specifically, between the core 1 of the first fiber optic cable and the core 1 of the second fiber optic cable, thereby minimizing signal loss between the respective cores 1 of the first and second fiber optic cables through the connector adapter 100.

The example connector adapter 100 shown in FIGS. 2-4 is designed and configured to maximize the flexibility of movements of the fiber optic cables during maintenance and/or installation actions performed with respect to the fiber optic cables within the datacenter. Such connector adapters 100 do not interfere with the fiber optic cable or connector efficiency and/or workability. Such connector adapters 100 have a construction that is configured such that a ramp adapter (e.g., 300, 400, 401, see FIGS. 7-20) can be removably attached to either of the longitudinal ends (e.g., the front side 110F and the rear side 110R) of the housing 110 of the connector adapter 100, the ramp adapter being configured to advantageously reduce the costs associated with maintenance and/or installation actions and also reduce the risk of damage to the fiber optic cables due to improper handling or movements (e.g., excessive bending, improper application of insertion force to the cable etc.) of the fiber optic cable, which is known to cause reduced signal transmission performance.

In order to effectuate these benefits, example embodiments of ramp adapters 300, 400, 401 are disclosed herein, features of which are shown in FIGS. 7-20. These ramp adapters 300, 400, 401 are attachable to either of the front or rear sides 110F, 110R of a connector adapter 100 in which the ports 50 of such connector adapter 100 are formed. These ramp adapters 300, 400, 401 comprise, extending away from the front or rear side 110F, 110R of the connector adapter 100 to which such ramp adapter 300, 400, 401 is attached, an extension portion 320, 420 that supports and guides a terminal connector of a fiber optic cable into a designated one of the ports 50 of the connector adapter 100 during the cable insertion process, thus avoiding damage to the core 1, or ferrule, of the fiber optic cable during cable maintenance and/or installation actions.

By attaching a ramp adapter 300, 400, 401 having such an extension portion 320, 420 onto a connector adapter 100, the workability of the cable installation is enhanced, and the time associated with maintenance and/or installation actions for insertion of a cable connector is reduced, commensurately reducing the cost associated with such maintenance and/or installation actions. The extension portion 320, 420 of such example ramp adapters 300, 400, 401 prevents, or at least reduces, the occurrence of restricted movements during the cable insertion process, since the extension portion 320, 420 acts as a guide for the connector while also protecting the core 1, or ferrule, of the connector from damage during the cable insertion or removal process.

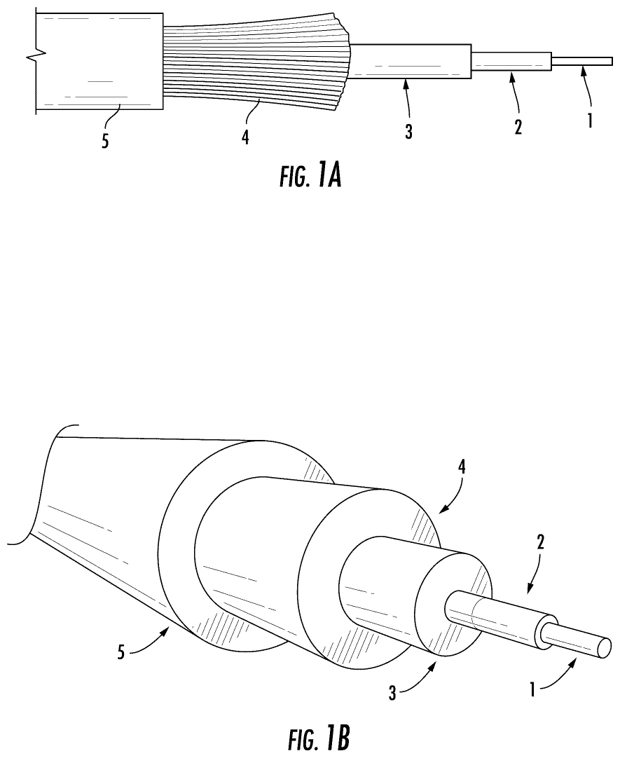

Referring to FIGS. 1A and 1B, respective side and perspective views of an example embodiment of a conventional fiber optic cable are shown. There is a core 1 at the center of the cable. In some instances, the core 1 may comprise multiple fiber optic filaments. The core 1 is surrounded by a cladding 2, which can also be referred to as a “cladding layer.” The filament(s) in the core 1 can also be referred to as ferrules. In some instances, each filament in the core 1 of a multi-filament fiber optic cable may have its own cladding 2. The cladding layer(s) 2 is/are surrounded by a coating 3, which can also be referred to as a “coating layer.” Strengthening fibers 4 are provided around the coating 3 and are surrounded by an outer cable jacket 5. When terminated, the filament(s) of the core 1 are inserted and secured within a connector such that, when the connector is inserted within a port 50 of a connector adapter 100, the connector is held in a prescribed position and, commensurately, the filament(s) are also held in a prescribed position by engagement of the connector with the port 50 of the connector adapter 100. It is these connectors, attached to the fiber optic cable generally of the type shown in FIGS. 1A and 1B, that are installed into the fiber optic connector adapters 100 shown in FIGS. 2-4, with the aid of a ramp adapter 300, 400, 401, example embodiments of which are shown in FIGS. 7-20.

FIGS. 2-4 show an example embodiment of a conventional multi-port fiber optic connector adapter 100. The connector adapter 100 comprises a housing 110. One or more (e.g., a plurality of) ports 50 are formed on opposing front and rear sides 110F, 110R of the housing 110. Thus, there are ports 50 formed on both the front side 110F and the rear side 110R of the housing 110, including a first subset of ports 50 formed on the front side 110F of the housing 110 and a second subset of ports 50 formed on the rear side 110R of the housing 110. Each port 50 of the first subset of ports 50 extends towards a corresponding port 50 of the second subset of ports 50, such that a plurality of cavities or passages (e.g., volumetric regions) are formed extending (e.g., continuously) between one of the ports 50 of the first subset of ports 50 and one of the ports 50 of the second subset of ports 50. Thus, there are as many cavities defined through the housing 110 as there are pairs of ports 50 on the front or rear sides 110F, 110R of the housing 110. In the example embodiment shown, the cavities are fully separated or isolated from each other in the z-direction by internal walls, which extend the full height of the cavity formed by such internal wall within the housing 110. These internal walls can extend continuously through the housing 110, from the front side 110F to the rear side 110R. In some embodiments, the internal walls may extend over only a portion of the height (e.g., in the y-direction) of the housing 110, in which case the cavities would not be fully separated or isolated from each other in the z-direction by such internal walls. In some embodiments, the internal walls may be partially or entirely omitted, such that the cavities would not be separated or isolated from each other in the z-direction whatsoever. The connector adapters 100 with which the ramp adapters 300, 400, 401 disclosed herein are configured to be installed on are not restricted to the example multi-port connector adapters 100 shown and discussed herein; thus, a ramp adapter for use with connector adapter having only a single port on the front and rear sides thereof is also within the scope of the present disclosure. Such a ramp adapter would necessarily only have a single ramp (e.g., 322) and no divider (e.g., 326).

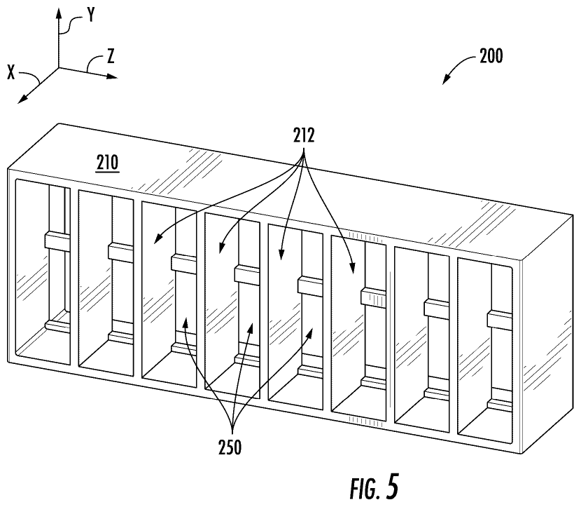

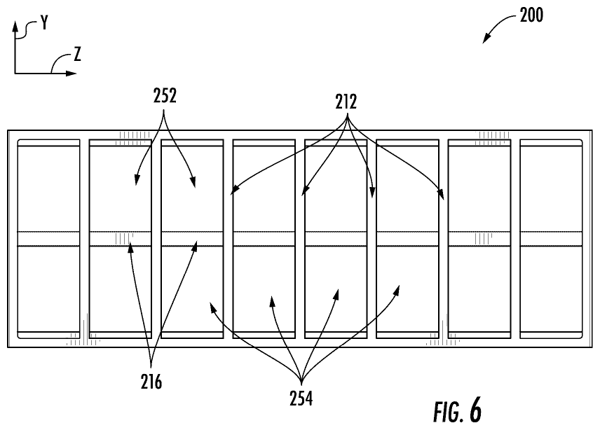

The housing 110 has a fastener 114 configured to secure the housing 110 to a panel, such as a network patch panel or the example connector adapter installation housing, generally designated 200, shown in FIGS. 5 and 6. Any suitable fastener type may be used for the fastener 114. The fastener 114 is preferably of a type by which the housing 110 may be selectively inserted into and removed from the network patch panel or connector adapter installation housing 200 in a tool-less manner (e.g., manually, using only the human hand without the aid of any tool).

The ramp adapters 300, 400, 401 disclosed herein can comprise or consist of any suitable material, including plastic, ceramic, and/or metal.

The fiber optic connector adapter 100 shown in FIGS. 2-4 is merely an example of the type of connector adapter 100 with which a ramp adapter 300, 400, 401 can be used. The quantity of ports 50 for a connector adapter 100 with which such ramp adapters 300, 400, 401 may be used is not limited to any specific quantity or number of ports 50.

The ports 50 of the example connector adapter 100 disclosed herein are of a type suitable for coupling together terminated connectors of fiber optic cables. An example of a suitable fiber optic cable connector includes a very small form factor (VSFF) multi-fiber optical connector. These connector adapters 100 are configured for insertion or attachment to a panel, preferably, a network patch panel, which is also referred to herein as the connector adapter installation housing 200. Thus, a network patch panel or connector adapter installation housing 200 comprising a plurality of the presently disclosed example connector adapters 100 installed therein is also disclosed herein. Similarly, a network installation comprising such a network patch panel or connector adapter installation housing 200 and a plurality of cables with connectors inserted into the ports 50 of the presently disclosed example connector adapters 100 is also disclosed herein.

FIGS. 5 and 6 show an example embodiment of a connector adapter installation housing, generally designated 200, into which a plurality of the connector adapters 100 shown in FIGS. 2-4 can be removably installed, as described elsewhere herein. The connector adapter installation housing 200 has a housing 210. The housing 210 has generally vertically-extending vertical divider walls 212 that define cavities, generally designated 250, within the housing 210. In some embodiments, each cavity 250 is shaped to accept therein one of the connector adapters 100 shown in FIGS. 2-4. In the example shown in FIGS. 5 and 6, each of the cavities 250 can be regarded as being subdivided into an upper cavity, generally designated 252, and a lower cavity, generally designated 254. The upper cavities 252 are configured to have a connector adapter 100 installed therein and to retain such connector adapter 100 vertically above another connector adapter 100 installed within the lower cavity 254. To define the upper and lower cavities 252, 254, the housing 210 has a horizontal wall 216 formed in each of the cavities 250, internal to such cavities 250, substantially at a vertical midpoint of the cavity 250, such that each of the upper cavities 252 are substantially the same volume as each of the lower cavities 254. The upper and lower cavities 252, 254 are separated, at least partially, by the respective horizontal walls 216.

FIGS. 7-10 show a first example embodiment of a ramp adapter, generally designated 300, configured for removable installation on either of the front or rear sides 110F 110R of the example connector adapter 100 shown in FIGS. 2-4. The ramp adapter 300 comprises an extension portion 320 that, when the ramp adapter 300 is in an installed position on the connector adapter 100, abuts against the adjacent front or rear side 110F, 110R of the connector adapter 100, depending on whether the ramp adapter 300 is installed on the front side 110F or the rear side 110R of the connector adapter 100. The top edge or surface of the extension portion 320 is substantially coplanar with the bottom surface of the cavity defined by the ports 50 of the connector adapter 100 with which such ramp adapter 300 is configured to be attached.

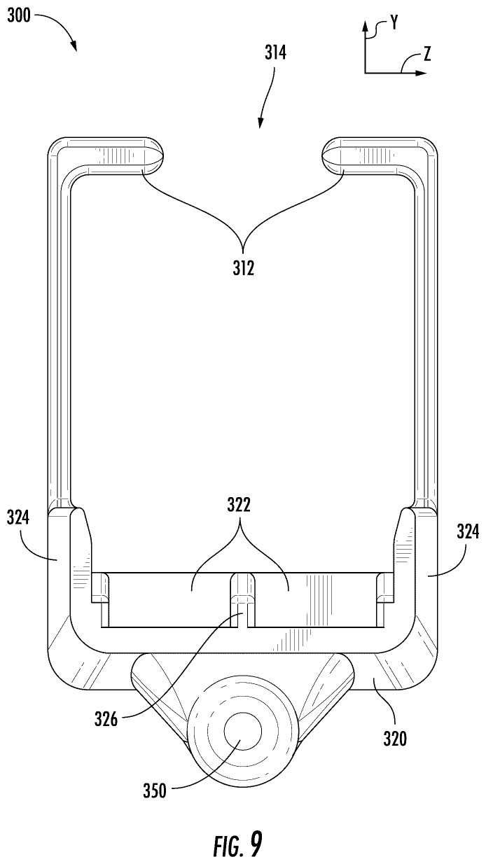

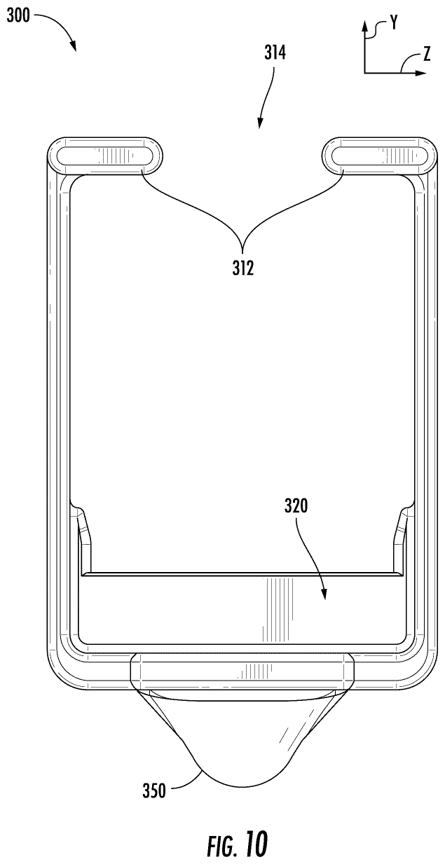

The ramp adapter 300 also has, extending vertically away from the extension portion 320, two fastening portions 312. The fastening portions 312 are on opposite lateral sides of the extension portion 320 from each other, the term “lateral” being the Z-direction shown in the figures. The fastening portions 312 have a generally L-shaped profile, when viewed along this longitudinal direction (e.g., along the X-direction, see FIGS. 9 and 10). The distal “leg” of the L-shaped profile of both of the fastening portions 312 extends towards the distal “leg” of the other fastening portion 312 in the Z-direction and. A gap, generally designated 314, is defined in a space between the distal “legs” of the fastening portions 312. This gap 314 is smaller than a width of the connector adapter 100, as also measured in the Z-direction. The fastening portions 312 also each have a proximal “leg” that is connected to the extension portion 320 (e.g., to the side wall 324 thereof) and extends substantially vertically (e.g., in the Y-direction shown in the figures) away from the extension portion 320 to connect to the distal “leg” of the same fastening portion 312. Thus, the proximal “leg” of each fastening portion 312 is connected between (e.g., directly between) the extension portion 320 (e.g., one of the side walls 320 thereof) and the distal “leg” of the same fastening portion 312.

The distal “leg” of each of the fastening portions 312 can have an upper tab 318 (e.g., formed in a monolithic manner with the distal “leg” of the fastening portion 312), that extends in a plane defined by the Z- and X-directions. The upper tab 318 is configured, when the ramp adapter 300 is attached to the connector adapter 100, to engage with a corresponding retention feature or slot formed in the housing 110 of the connector adapter 100 and/or within a slot defined between the housing 210 of the connector adapter installation housing 200 and the housing 110 of the connector adapter 100, such that the upper tab 318 resists unintentional removal of the ramp adapter 300 from the connector adapter 100. The lower edge of the extension portion 320 has a lower tab 316 (e.g., that is formed in a monolithic manner with the extension portion 320) that has a same general shape and orientation as the upper tab 318, the plane in which the lower tab 316 extends being parallel to or substantially parallel (e.g., within 5°, within 2°, within 1°) to the plane in which the upper tab 318 extends. The lower tab 316 is configured, when the ramp adapter 300 is attached to the connector adapter 100, to engage with a corresponding retention feature or slot formed in the housing 110 of the connector adapter 100 and/or within a slot defined between the housing 210 of the connector adapter installation housing 200 and the housing 110 of the connector adapter 100, such that the lower tab 316 resists unintentional removal of the ramp adapter 300 from the connector adapter 300. The lower and/or upper tabs 316, 318 may, in some embodiments, be secured to the housing 110 of the connector adapter 100 using an interference, or frictional, fit, meaning that the lower and upper tabs 316, 318 are compressed against the outer surface of the housing 110 of the connector adapter 100 and/or are wedged into a corresponding retention feature or slot defined between the housing 210 of the connector adapter installation housing 200 and the housing 110 of the connector adapter 100. In some embodiments, the lower and upper tabs 316, 318 may have a tapering shape, the thickness thereof in the Y-direction decreasing as a function of distance away from the surface of the ramp adapter 300 to which such lower and upper tab 316, 318, respectively, is attached.

The distance in the Z-direction between the proximal “legs” of the fastening portions 312 is the same as or greater than the width of the housing 110 of the connector adapter 100 to which the ramp adapter 300 is designed to be removably attached.

The extension portion 320 of the ramp adapter 300 extends, when the ramp adapter 300 is attached to a connector adapter 100, away from the housing 110 of the connector adapter 100 in the X-direction. The extension portion 320 has side walls 324 that define the outer shape of the extension portion 320 in the Z-direction. In some embodiments, the side walls 324 extend generally in the X-Y plane. In the example embodiment shown in FIGS. 7-10, it can be seen, perhaps best in FIG. 9, that the distance between the outer surface of the side walls 324 tapers as the side walls 324 extend in the direction of the grip 350, in the X-direction. A ramp 322, or sloped surface, is provided between the side walls 324 of the extension portion 320. The ramp 322 terminates at the upper edge or surface of the extension portion 320.

The extension portion 320 comprises a divider 326 (e.g., in the form of generally triangularly-shaped walls). The divider 326 extends along the sloped surface in the X-direction, bifurcating the sloped surface and forming a ramp 322 on each side of the divider 326 in the Z-direction. Thus, the ramp 322 on each side of the divider 326 is delimited by the distance between the divider 326 and one of the side walls 324. A height of the dividers 326 above the sloped surface of the ramp 322 changes along the length of the extension portion 320 in the X-direction. As shown, the divider 326 can have a height above the sloped surface of the ramp 322 that decreases as a function of proximity to the side of the housing 110 of the connector adapter 100 to which the ramp adapter 300 is, was, or will be attached.

The sloped surface of the ramp 322 tapers generally away from the front or rear side 110F, 110R of the housing 110 of the connector adapter 100 to which the ramp adapter 300 is attached. Thus, the sloped surface of the ramp 322 is, at the end farthest away from the front/rear side 110F, 110R of the housing 110 of the connector adapter 100, lower (i.e., in the Y-direction) than at the upper edge of the extension portion 320. Stated somewhat differently, the sloped surface of the ramp 322 is inclined such that an angle α between the surface of the ramp 322 and the bottom surface of the cavity contacted by the connector is greater than 180°.

The divider 326 defines channels on either side thereof, each channel being aligned with (e.g., coaxial to) one of the ports 50 of the connector adapter 100 to which the ramp adapter 300 is, was, or will be is attached. The width of these channels and/or ramps 322 is (e.g., in the Z-direction) the same as or wider than the width of the connector to be inserted within the port 50 of the connector adapter 100. Thus, during insertion, the connector rests on the ramp 322 within one of the channels and can be slid along the ramp in the direction of insertion (e.g., in the X-direction) to guide the connector into the port 50 of the connector adapter 100 designated to receive the connector therein. Thus, the extension portion 320 is configured to align the connector with the port 50 such that an alignment is maintained by engagement of the connector within the channel of the ramp adapter 300 as the connector is moved towards the port 50 of the connector adapter 100 designated to receive the connector therein. The extension portion 320 is configured such that the act of placing the connector within one of the channels, or on one of the ramps 322, self-aligns the connector with the port 50 associated with the channel or ramp 322. Thus, by using the ramp adapters 300 described herein, misalignments between the cable connector and the port 50 that are known to cause damage to the ferrules of the fiber optic cable connector can be prevented.

The ramp adapter 300 also has a grip 350 that extends away from the extension portion 320 in the X-direction. The grip 350 is shaped to be grasped by a human hand, or at least two or more fingers of a human hand, and pushed towards the connector adapter 100 to install the ramp adapter 300 on such connector adapter 100 and also pulled away from the connector adapter 100 to remove the ramp adapter 300 from such connector adapter 100. The grip 350 may, in some instances, have a circle, loop, hook, or pull ring attached at an end thereof to allow removal of the ramp adapter 300 from the connector adapter 100 using only one finger. The grip 350 is advantageously positioned between ramps 322, such that the grip 350 will not interfere with any of the cables hanging vertically down from the respective connector inserted into one of the ports 50 of the connector adapter 100.

During a method of use of the connector adapter 100, a ramp adapter 300 is attached to a front side 110F or a rear side 110R of the connector adapter 100, a connector attached at a terminal end of a fiber optic cable is positioned to rest within a designated channel (e.g., on one of the ramps 322), the connector is slid along the ramp 322 towards the port 50 into which such connector is to be inserted, and the connector is inserted into such port 50 when the connector reaches the end of the ramp 50 at the front or rear side of the connector adapter 100. This process is repeated until all of the designated ports 50 of the connector adapter 100 have connectors installed therein, then the ramp adapter 300 is grasped by the grip 350, a force is applied to the grip 350 in the direction of separation of the ramp adapter 300 from the connector adapter 100, and the ramp adapter 300 is then removed from the connector adapter 100.

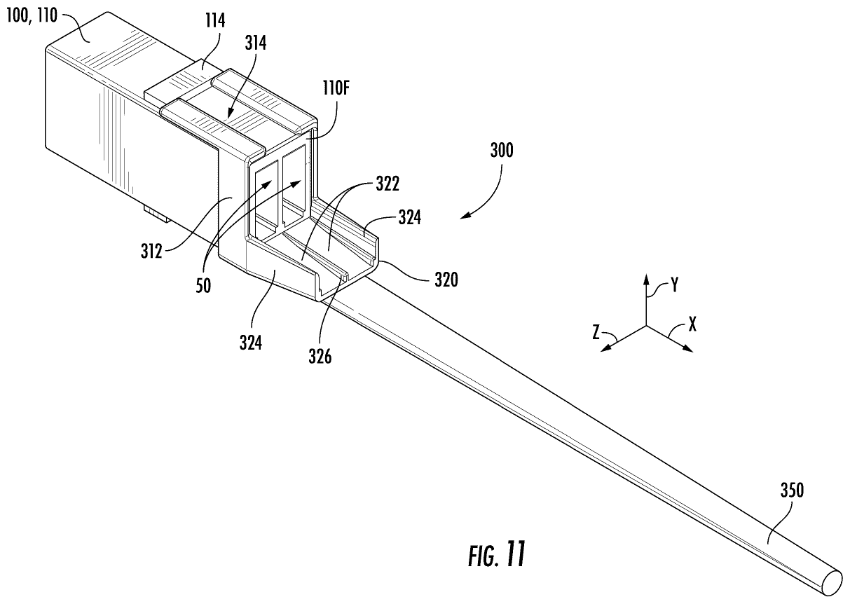

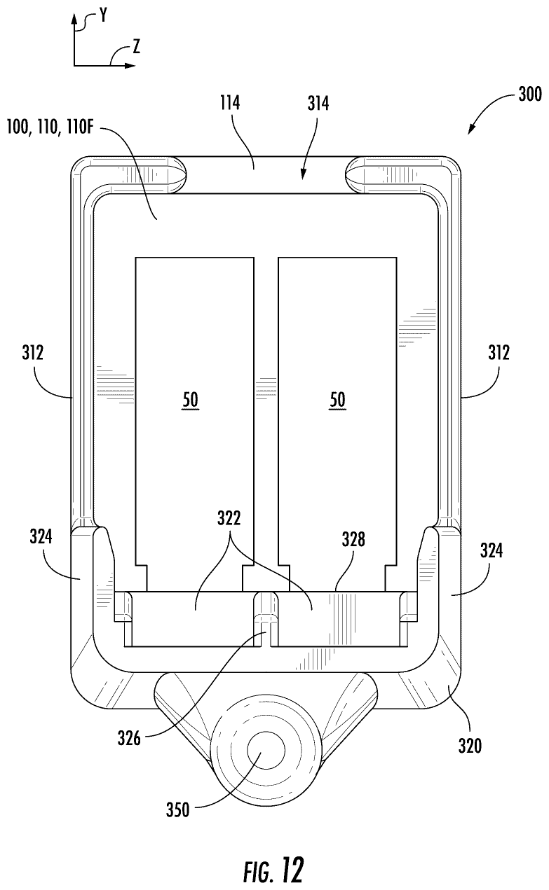

FIGS. 11 and 12 show a ramp adapter 300 installed onto a front side 110F of a connector adapter 100. The gap 314 is provided so the ramp adapter 300 can be installed on the connector adapter 100 with a cable already connected to (e.g., with the connector of the cable already installed within one of the ports 50 of) the connector adapter, thereby facilitating safe removal of a connector of the cable from a port 50 of the connector adapter 100, and also so the ramp adapter 300 can be removed from the connector adapter 100 with a cable extending out of the port 50 of the connector adapter 100, thereby allowing the ramp adapter 300 to be removed after it has been used to guide the connectors of cables into the designated ports 50 into which such connectors are to be installed. In other words, the width of the gap 314 in the Z-direction is advantageously at least as large as, or larger than, the diameter of the cable of the connector installed or to be installed in the connector adapter 100. In some instances, the distal “legs” of the fastener portions 312 can be deflected away from each other to allow for passage through the gap 314 of a cable with a diameter that is larger than the gap 314 when the fastener portions 312 are not in a deflected position. As shown, the upper edge of the ramp(s) 322 is/are in the same plane as the bottom surface of the ports 50 of the connector adapter 100.

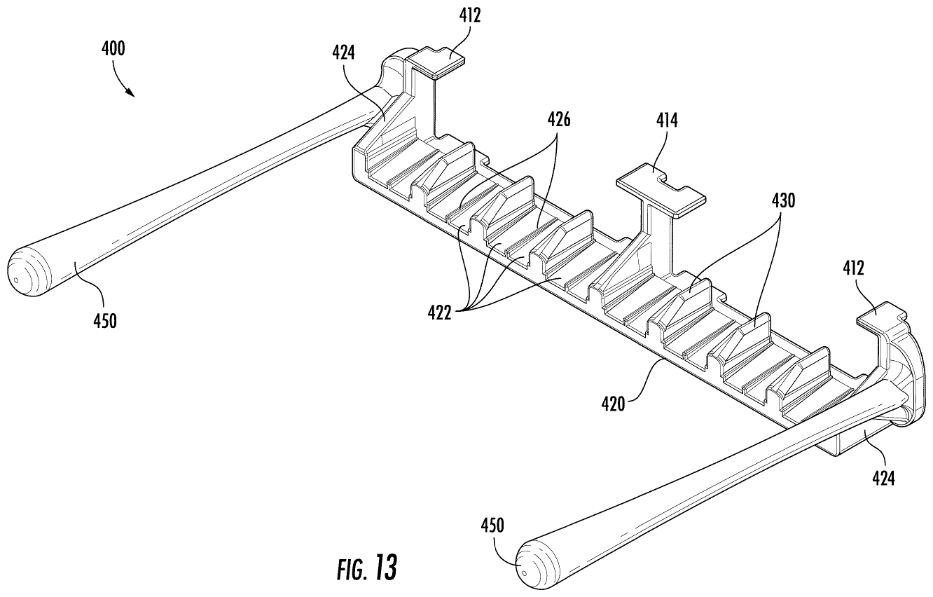

The ramp adapters 300 disclosed herein are merely examples and are not limited in any way to having any specific quantity of ramps. Thus, the ramp adapters 300 disclosed herein may have any suitable quantity of ramps 322. An example of a ramp adapter, generally designated 400, having more than two (2) ramps 422 is shown in FIGS. 13-18.

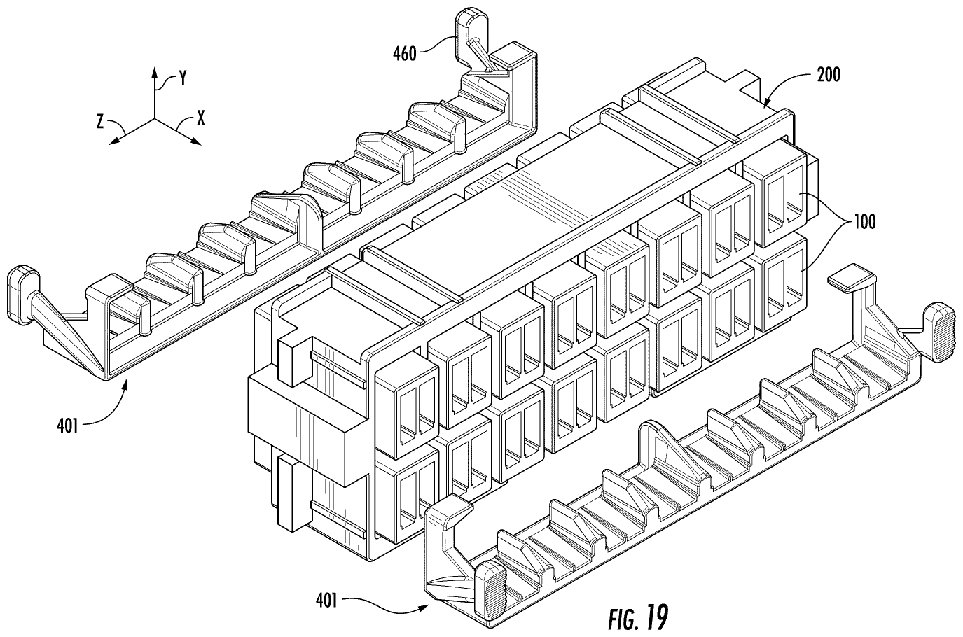

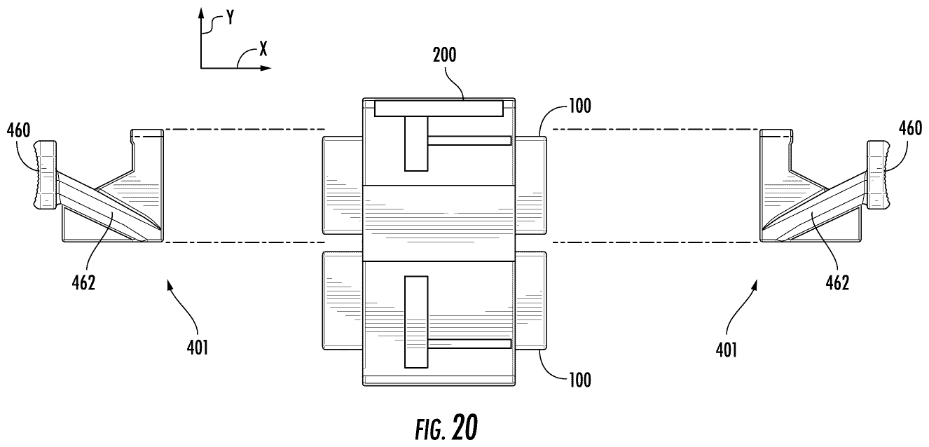

The ramp adapter 400, shown in FIGS. 13-18, has generally a similar construction to the ramp adapter 300 shown in FIGS. 7-10. The ramp adapter, generally designated 401, shown in FIGS. 19 and 20, has a generally similar construction to the ramp adapters 300, 300. Structures of the ramp adapters 400, 401 that are substantially similar to corresponding structures of the ramp adapter 300 may not be described herein again, however, reference should be made to the corresponding structure(s) of the ramp adapter 300 in understanding the structures of the ramp adapters 400, 401 that may not be fully described herein. Unless described herein as being different, like structures between the ramp adapters 300, 400, 401 should be regarded as being the same as each other. Given their similarity in structure, the ramp adapters 400, 401 will be described herein together, with the differences between such ramp adapters 400, 401 being noted and described herein.

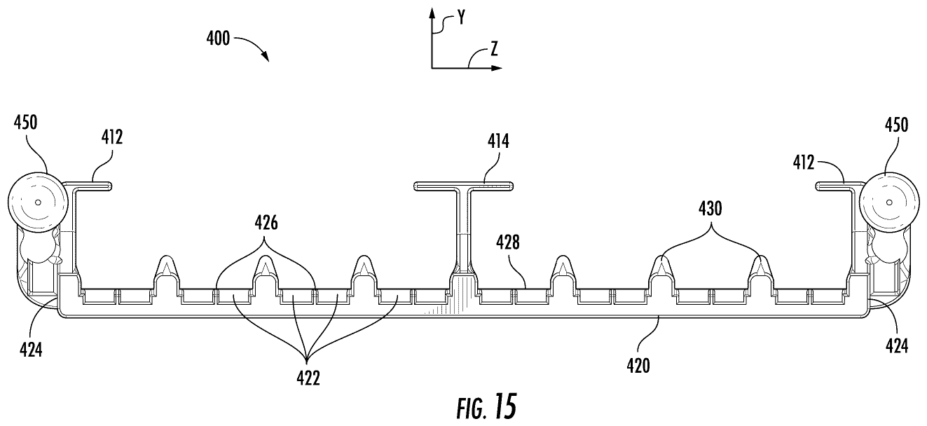

The ramp adapters 400, 401 comprise an extension portion 420 that extends away from the side (e.g., the front side 110F or the rear side 110R) of the connector adapter 100, to which such ramp adapter 400, 401 is attached, in the X-direction. The extension portion 420 has side walls 424 that define the outer shape of the extension portion 420 in the Z-direction. In the example embodiment shown in FIGS. 13-18, it can be seen, perhaps best in FIG. 15, that the side walls 424 extend generally in the X-Y plane. In some embodiments, the distance between the outer surface of the side walls 424 tapers as they extend (e.g., as a function of distance from the connector adapter 100) in the direction of the grip 450.

One or more ramps 422, or sloped surfaces, is/are provided between the side walls 424 of the extension portion 420. The ramps 422 terminate at the upper edge 428 or surface of the extension portion 420. The extension portion 420 comprises dividers 426 (e.g., walls) that are spaced apart from each other in the Z-direction and extend along the length of the ramps 422 in the X-direction. The dividers 426 are each formed so as to have a top surface that is substantially coplanar with each other. A height of the dividers 426 above the sloped surface of the ramps 422 changes along the length of the extension portion 420 in the X-direction. As shown, the dividers 426 can have a height above the sloped surface of the ramps 422 that decreases as a function of proximity to the side (e.g., the front side 110F or the rear side 110R) of the housing 110 against which the extension portion 420 is abutted when the ramp adapter 400 is attached to the connector adapters 100. The dividers 426 of the extension portion 400 are preferably coplanar with the walls or other dividers within the housing 110 of the connector adapter 100 that define the respective cavities extending between opposing ports 50 within the housing 100.

Since, in these example embodiments shown in FIGS. 13-20, the ramp adapters 400, 401 are each configured to be removably attached to a quantity of eight (8) two-port connector adapters 100, the ramps 422 of such ramp adapters 400, 401 are grouped into pairs of ramps 422 that are spaced apart from each other in the Z-direction by the same distance as the ports 50 of the same connector adapter 100, while each pair of ramps 422 is spaced apart in the Z-direction from an adjacent pair of ramps 422 by a distance that accounts for the space between laterally adjacent connector adapters 100, as well as the thickness of the sidewalls of the housing 110 of the two laterally adjacent connector adapters 100. To provide this spacing, intermediate walls 430 are provided between one pair of ramps 422 and another pair of ramps 422 that is laterally adjacent thereto. This thickness (e.g., in the Z-direction) is substantially similar to the space between laterally adjacent connector adapters 100 (e.g., the thickness of the vertical walls of the connector adapter installation housing 200, see FIGS. 5 and 6), as well as the thickness of the sidewalls of the housing 110 of the two laterally adjacent connector adapters 100.

The ramp adapters 400, 401 also have, extending vertically away from the opposing lateral edges of the extension portion 420, two lateral fasteners 412. The terms “lateral fasteners” and “fastening portion” can be used interchangeably, since the construction of both is substantially the same. The lateral fasteners 412 are on opposite sides of the extension portion 420 from each other in the Z-direction. The lateral fasteners 412 have a generally L-shaped profile, when viewed in this X-direction, the distal “leg” of the L-shaped profile of both of the lateral fasteners 412 extending towards each other in the Z-direction, defining a gap between the upper portion of the median fastener 414, described elsewhere herein, and the end of the distal “leg” of the L-shaped profile of the respective lateral fastener 412. This gap, as shown in the example embodiments shown in FIGS. 13-16, spans multiple connector adapters 100 in the Z-direction. The lateral fasteners 412 also each have a proximal “leg” that is connected to the extension portion 420 and extends substantially vertically (e.g., in the Y-direction shown in the figures) away from the extension portion 420 to connect to the distal “leg” of the same lateral fasteners 412.

The distal “leg” of each of the lateral fasteners 412 can have an upper tab 418 (e.g., formed in a monolithic manner with the distal “leg” of one of the lateral fasteners 412), that extends in a plane defined by the Z- and X-directions. The upper tab 418 is configured, when the ramp adapter 400, 401 is attached to the connector adapter 100, to engage with a corresponding retention feature or slot formed in the housing 110 of the connector adapter 100 and/or within a slot defined between the housing 210 of the connector adapter installation housing 200 and the housing 110 of the connector adapter 100, such that the upper tab 418 resists unintentional removal of the ramp adapter 400, 401 from the connector adapter 100. The lower edge of the extension portion 420 has a lower tab 416 (e.g., that is formed in a monolithic manner with the extension portion 320) that has a same general shape and orientation as the upper tab 418, the plane in which the lower tab 416 extends being parallel or substantially parallel (e.g., within 5°, within 2°, within 1°) to the plane in which the upper tab 418 extends. The lower tab 416 is configured, when the ramp adapter 400, 401 is attached to the connector adapter 100, to engage with a corresponding retention feature or slot formed in the housing 110 of the connector adapter housing and/or within a slot defined between the housing 210 of the connector adapter installation housing 200 and the housing 110 of the connector adapter 100, such that the lower tab 416 resists unintentional removal of the ramp adapter 400, 401 from the connector adapter 100. The lower and/or upper tabs 416, 418 may, in some embodiments, be secured to the housing 110 of the connector adapter 100 using an interference, or frictional, fit, meaning that the lower and upper tabs 416, 418 are compressed against the outer surface of the housing 110 of the connector adapter 100 and/or are wedged into a corresponding retention feature or slot defined between the housing 210 of the connector adapter installation housing 200 and the housing 110 of the connector adapter 100. In some embodiments, the lower and upper tabs 416, 418 may have a tapering shape, the thickness thereof in the Y-direction decreasing as a function of distance away from the surface of the ramp adapter 400 to which such lower and upper tab 416, 418, respectively, is attached.

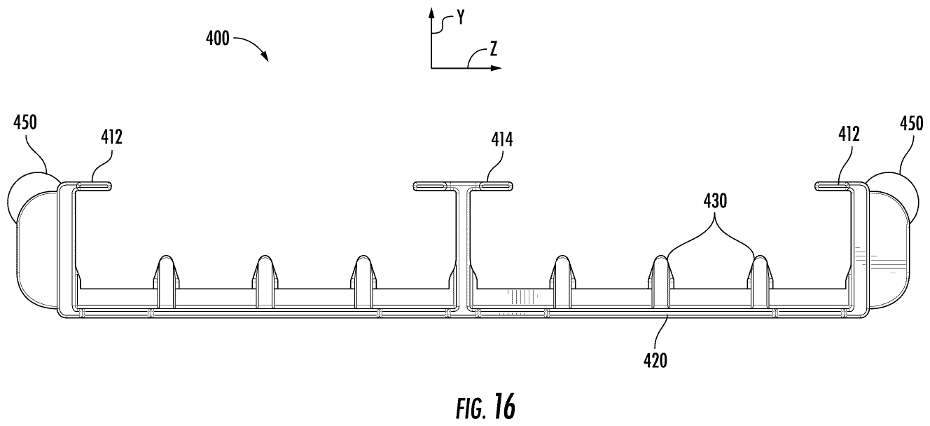

In order to provide sufficient structural rigidity for the extension portion 420 of the ramp adapter 400, 401, the center intermediate wall has a median fastener 414 attached thereto, the median fastener 414 having a generally T-shaped profile when viewed from the front or the rear of the ramp adapter (see, e.g., FIGS. 15 and 16). The upper portions of the median fastener 414 (e.g., the portions thereof that protrude in the Z-direction from the median fastener) engage within a corresponding retention feature or slot in the housing 110 of the connector adapter 100 and/or within a retention feature or slot defined between the housing 210 of the connector adapter installation housing 200 and the housing 110 of the connector adapter 100. In some embodiments, the upper portions of the median fastener 414 may have structures that are substantially similar to the upper tabs 418 discussed elsewhere herein with respect to the lateral fasteners 412 and the fastening portions 312. In such embodiments, the upper tabs 416 work identically to other upper tabs 316 described elsewhere herein.

The extension portion 420 has, on an upper surface thereof, a sloped or inclined surface, such that a thickness of the ramps 422 tapers away from the side (e.g., the front side 110F or the rear side 110R) of the connector adapter 100 to which the ramp adapter 100 is attached. Thus, the sloped surface of the ramps 422 is, at the end farthest away from the connector adapter 100, lower (i.e., in the y-direction) than at the upper edge 428 of the extension portion 420. Stated somewhat differently, the sloped surface of the extension portion 420 is inclined such that an angle α between the surfaces of the ramps 422 and the bottom surface of the cavity contacted by the connector is greater than 180°. These sloped surfaces of the extension portion 420 form the ramps 422, which are divided into pairs of ramps 426 separated by a divider 426.

The dividers 426 define channels on either side thereof, each channel having a substantially similar width as the corresponding ramp 422 and being aligned with (e.g., coaxial to) one of the ports 50 of the connector adapter 100 to which the ramp adapter 400, 401 is, was, or will be is attached. The width of these channels and/or ramps 422 is (e.g., in the Z-direction) the same as or wider than the width of the connector to be inserted within the port 50 of the connector adapter 100. Thus, during insertion, the connector rests on the ramp 422 within one of the channels and can be slid along the ramp 422 in the direction of insertion (e.g., in the X-direction) to guide the connector into the port 50 of the connector adapter 100 designated to receive the connector therein. Thus, the extension portion 420 is configured to align the connector with the port 50 such that an alignment is maintained by engagement of the connector within the channel of the ramp adapter 400, 401 as the connector is moved towards the port 50 designated to receive the connector therein. The extension portion 420 is configured such that the act of placing the connector within one of the channels and/or on the ramp 422 associated with such channel self-aligns the connector with the port 50 associated with the channel. Thus, by using the ramp adapters 400, 401 described herein, misalignments between the cable connector and the port 50 that are known to cause damage to the ferrules of the fiber optic cable connector can be prevented.

The ramp adapter 400 has two grips 450 that are attached laterally outboard of (e.g., in the Z-direction) the lateral fasteners 412 so that the grips 450 will not interfere with any of the cables hanging vertically down from the respective connector inserted into one of the ports 50 of the connector adapter 100. Each of the grips 450 extends away from the extension portion 420 in the X-direction. The grips 450 are each shaped to be grasped by a human hand, or at least two or more fingers of a human hand, and pushed towards the connector adapter installation housing 200 to install the ramp adapter 400 to be aligned such that the ramps 422 of the ramp adapter 400 are aligned with the ports 50 of the connector adapters 100 of the connector adapter installation housing 200 and also pulled away from the connector adapter installation housing 200 to remove the ramp adapter 400 from such connector adapter installation housing 200. The grips 450 may, in some instances, have a circle, ring, or other suitable structure attached at an end thereof to allow removal of the ramp adapter 400 from the connector adapter installation housing 200 using only one finger per grip 450.

During a method of use of the connector adapter 100, a ramp adapter 400 is attached to a front side or a rear side of the connector adapter installation housing 200, a connector attached at a terminal end of a fiber optic cable is positioned to rest within a designated channel (e.g., on one of the ramps 422 of the ramp adapter 400), the connector is slid along the ramp 422 towards the port 50 into which such connector is to be inserted, the connector is inserted into such port 50 when the connector reaches the end of the ramp 422 at the front or rear side 110F, 110R of the housing 110 of the connector adapter 100. This process is repeated until all of the designated ports 50 of all of the connector adapters 100 have connectors installed therein, then the ramp adapter 400 is grasped by the grips 450, a force is applied to the grips 450 in the direction of separation of the ramp adapter 400 from the connector adapter installation housing 200, and the ramp adapter 400 is then removed from the connector adapter installation housing 200.

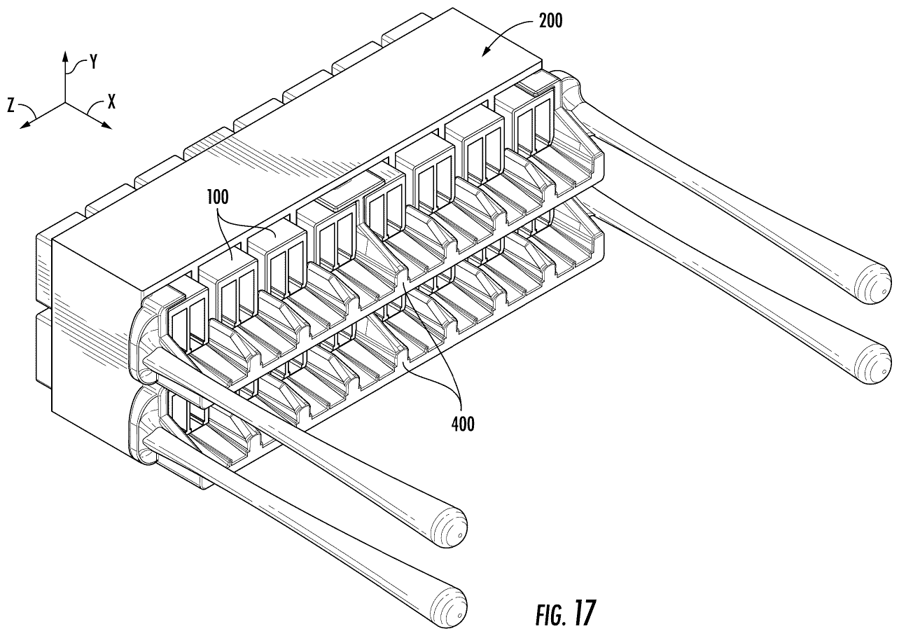

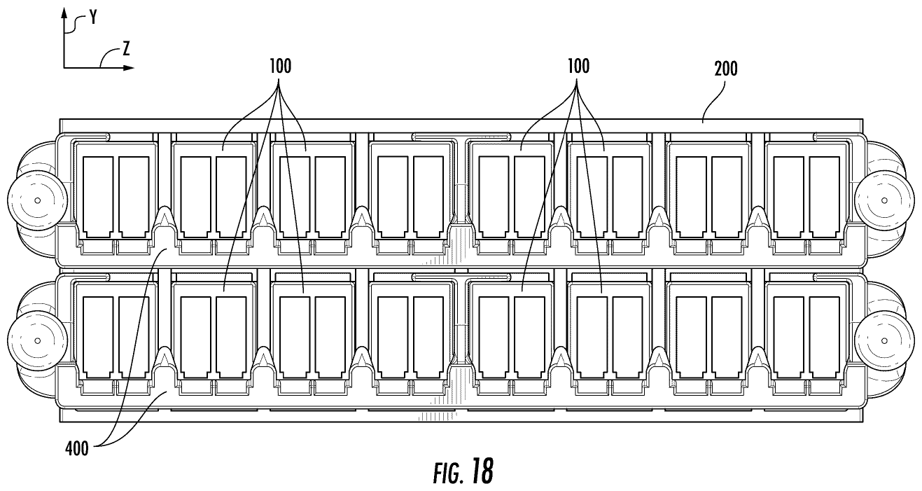

FIGS. 17 and 18 show a plurality of the ramp adapters 400 of FIGS. 13-16 installed onto a front side of a connector adapter installation housing 200, the connector adapter installation housing 200 having installed therein a total of 16 connector adapters 100 of the type shown in FIGS. 2-4, the connector adapters 100 being arranged in a 2×8 configuration, or 2 rows of 8 connectors each. The respective gaps between the median fastener 414 and each of the lateral fasteners 412 are provided so the ramp adapter 400 can be installed on the connector adapter installation housing 200 that has cables already connected to one or more (e.g., all of) the connector adapters 100 installed in the connector adapter installation housing 200, thereby facilitating safe removal of a connector of the cable from a port 50 of one of the connector adapters 100, and also so the ramp adapter 400 can be removed from the connector adapter installation housing 200 with cables extending out of the ports 50 of the connector adapters 100 of the connector adapter installation housing 200, thereby allowing the ramp adapter 400 to be removed after it has been used to guide the connectors of cables into the designated ports 50 into which such connectors are to be installed.

FIGS. 19 and 20 show different perspective views of a partially exploded assembly view of yet another example embodiment, the ramp adapter generally designated 401, which can be installed onto a front or rear side of a connector adapter installation housing 200. The connector adapter installation housing 200 shown has a total of 16 connector adapters of the type shown in FIGS. 2-4 installed therein, the connector adapters 100 being arranged in a 2×8 configuration, or 2 rows of 8 connectors each. The alignment of the ramp adapters 401 relative to the connector adapters 100 with which each ramp adapter 401 is aligned for installation thereon is indicated schematically by the dot-dash-dot lines shown in FIG. 20. The connector adapter installation housing 200 shown in FIGS. 19 and 20 is functionally identical to the connector adapter installation housing 200 shown in FIGS. 5 and 6. As noted elsewhere herein, the ramp adapters 401 shown in FIGS. 19 and 20 are substantially identical to the second example embodiment of the ramp adapter 400 shown and described with respect to FIGS. 13-18.

The ramp adapter 401 has, instead of the two grips 450 of the ramp adapter 400, a connector 462 that extends away from the extension portion 420, with a push surface 460 attached at the end of each connector 462. The connectors 462 are attached laterally outboard of (e.g., in the Z-direction) the lateral fasteners 412 so that the connectors 462 and the push surfaces 460 will not interfere with any of the cables hanging vertically down from the respective connector inserted into one of the ports 50 of the connector adapter 100. Each of the connectors 462 and the push surfaces 460 extends away from the extension portion 420 in the X-direction. The push surfaces 460 are each shaped to be pushed, during installation, by the fingers or thumbs of a user to secure the ramp portion 401 onto the connector adapters 100 and the connector adapter installation housing 200. The push surface 460 is also shaped so that a user can, during removal of the ramp adapter 401 from the connector adapters 100, grasp behind the upper and lower flanges of the push surface 460 using, for example, a finger and thumb for grasping behind each push surface 460 and exerting a removal force on the ramp adapter 401 to separate the ramp adapter 401 from the connector adapters 100, thereby allowing the ramp adapter 401 to be removed after it has been used to guide the connectors of cables into the designated ports 50 into which such connectors are to be installed.

Otherwise, the ramp adapter 401, shown in FIGS. 19 and 20, is, as noted elsewhere herein, substantially identical both in form and function to the ramp adapter 400 of FIGS. 13-18.

During a method of use of the connector adapter 100, a ramp adapter 401 is attached to a front side or a rear side of the connector adapter installation housing 200, a connector attached at a terminal end of a fiber optic cable is positioned to rest within a designated channel (e.g., on one of the ramps 422 of the ramp adapter 401), the connector is slid along the ramp 422 towards the port 50 into which such connector is to be inserted, the connector is inserted into such port 50 when the connector reaches the end of the ramp 422 at the front or rear side 110F, 110R of the housing 110 of the connector adapter 100. This process is repeated until all of the designated ports 50 of all of the connector adapters 100 have connectors installed therein, then the ramp adapter 401 is grasped by the grips 450, a force is applied to the grips 450 in the direction of separation of the ramp adapter 401 from the connector adapter installation housing 200, and the ramp adapter 401 is then removed from the connector adapter installation housing 200.

While the present disclosure refers to certain embodiments, numerous modifications, alterations, and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The phrases “at least one”, “one or more”, and “and/or”, as used herein, are open-ended expressions that are both conjunctive and disjunctive in operation. The terms “a” (or “an”), “one or more” and “at least one” can be used interchangeably herein. All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., engaged, attached, coupled, connected, and joined) are to be construed broadly and may include intermediate members between a collection of elements and relative to movement between elements unless otherwise indicated. As such, connection references do not necessarily infer that two elements are directly connected and in fixed relation to each other. All rotational references describe relative movement between the various elements. Identification references (e.g., primary, secondary, first, second, third, fourth, etc.) are not intended to connote importance or priority but are used to distinguish one feature from another. The drawings are for purposes of illustration only and the dimensions, positions, order and relative to sizes reflected in the drawings attached hereto may vary.

1. A ramp adapter for guiding connectors of cables into a designated port of one or more connector adapters that is configured for coupling cables together, the ramp adapter comprising:
an extension portion that is configured to abut against a side of the one or more connector adapters that has/have the designated port when the ramp adapter is removably attached to the one or more connector adapters, wherein the extension portion extends away from the one or more connector adapters when the ramp adapter is removably attached to the one or more connector adapters;
fastening portions that are attached to the extension portion and are configured to removably attach the ramp adapter to the one or more connector adapters; and
one or more grips that are configured to be grasped by a user to guide the ramp adapter onto or away from the one or more connector adapters during installation of the ramp adapter onto the one or more connector adapters and during removal of the ramp adapter from the one or more connector adapters;
wherein the extension portion is configured to support and guide a connector attached to one of the cables into the designated port of the one or more connector adapters during insertion of the connector into the designated port.

2. The ramp adapter of claim 1, wherein the extension portion comprises a plurality of channels that are defined by dividers.

3. The ramp adapter of claim 2, wherein a quantity of the plurality of channels is the same as a quantity of ports of the one or more connector adapters to which the ramp adapter is configured to be removably attached.

4. The ramp adapter of claim 2, wherein the extension portion has a sloped surface on which the connector of the cable being inserted is supported, the sloped surface being angled such that, at an upper edge of the extension portion, the sloped surface and the ports of the one or more connector adapters are continuous with each other.

5. The ramp adapter of claim 4, wherein the sloped surface and a bottom surface of the ports of the one or more connector adapters are arranged at an obtuse angle relative to each other.

6. The ramp adapter of claim 5, wherein, at the side of the one or more connector adapters in which the designated port is located, the sloped surface and the bottom surface of the designated port are at a same height as each other.

7. The ramp adapter of claim 6, wherein the upper edge of the extension portion is coplanar with the bottom surface of the ports of the one or more connector adapters and all other parts of the sloped surface of the extension portion are below plane defined by the bottom surface of the ports.

8. The ramp adapter of claim 5, wherein the upper edge of the extension portion is coplanar with the bottom surface of the ports of the one or more connector adapters and all other parts of the sloped surface of the extension portion are below plane defined by the bottom surface of the ports.

9. The ramp adapter of claim 2, wherein the dividers are located so that located so that each channel of the plurality of channels is substantially coaxially aligned with a corresponding one of the ports of the one or more connector adapters.

10. The ramp adapter of claim 1, wherein the extension portion comprises a ramp.

11. The ramp adapter of claim 1, wherein the ramp adapter has a unitary or monolithic construction.

12. The ramp adapter of claim 1, wherein, during insertion of the connector into the designated port, the connector slides along the extension portion and a ferrule of the connector does not directly contact the ramp adapter.

13. The ramp adapter of claim 1, wherein the ramp adapter is made from one or more of a plastic material, a ceramic material, and a metal material.

14. The ramp adapter of claim 1, wherein the ramp adapter consists of a plastic material, a ceramic material, or a metal material.

15. The ramp adapter of claim 1, wherein the ramp adapter consists of one or more of a plastic material, a ceramic material, and a metal material.

16. The ramp adapter of claim 1, wherein the ramp adapter is configured to be removably attached to a plurality of connector adapters.

17. The ramp adapter of claim 15, wherein the plurality of connector adapters are installed in a connector housing installation housing.

18. The connector adapter of claim 1, wherein the cables are fiber optic cables.
